(19) United States
(12) Patent Application Publication
(10) Pub. No.: US 2003/0072216 A1
(43) Pub. Date: Apr. 17, 2003

(54) Dispersing apparatus

(76) Inventor: Yoshitaka Araki, Tokyo (JP)

Correspondence Address: DENNISON, SCHULTZ & DOUGHERTY, 612 Crystal Square 4, 1745 Jefferson Davis Highway, Arlington, VA, 22202-3417, US

(21) Appl. No.: 10/230,064

(22) Filed: Aug. 29, 2002

(30) Foreign Application Priority Data
Aug. 31, 2001 (JP) JP2001-264460

(51) Int. Cl. B01F 13/00

(52) U.S. Cl. 366/343

(57) ABSTRACT

To provide a dispersing apparatus which is capable of stirring media in a vessel uniformly and making it possible to conduct dispersion efficiently with fixed quality by enhancing shearing force. Blades made of a plate having fixed length in an axial direction of a shaft are protruded from the surface of an outer circumference of a shaft inserted in an axial direction of said vessel and rotated in said vessel in an outer circumferential direction of said shaft and plate-shaped fins are protruded on an inner wall surface of said vessel, and confronting said fins with an outer circumference of a forming position for said stirrer members with a direction toward an inner circumference of said vessel, and said plate-shaped fins have a fixed length without contacting with said stirrer members. When the shaft is rotated, the blades is capable of stirring the media in the vessel appropriately and the fins is operated as an obstacle to the media which are going to move in a rotational direction of the shaft therefore generated shearing force is increased then dispersion efficiency is improved.

### BACKGROUND OF THE INVENTION

1. Field of Invention

The present invention relates to a dispersing apparatus for dispersing a blend which is a fluid or a semi-fluid by stirring with dispersing media (hereinafter called “the media”) such as glass beads, ceramic beads and steel balls. More particularly, the invention relates to a dispersing apparatus dispersing the blend with shearing force generated among stirred media by passing the blend as a subject of dispersion through a cylindrical container as a vessel in which said media is thrown and stirred.

In this specification, the “blend” stands for a mixture of two or more kinds of starting materials, and the “dispersion” includes stirring or mixing.

2. Description of the Prior Art

For manufacturing the composition including a solid, the solid is dispersed in an element of each particle in a manufacturing field of paint or ink, chemicals and other articles.

For example, manufacturing of a coating composition including a solid such as paint or ink will be explained. The composition is prepared through a pre-kneading step for obtaining a paste by mixing, for example, a resin varnish and a pigment, a dispersion step for obtaining a mill base in which the pigment is uniformly dispersed in the resin varnish by dispersing the paste obtained through the pre-kneading step using a dispersing apparatus and a dissolving step for mixing and dissolving the mill base obtained through the above dispersion step with a solvent, resin varnish and as required, additives by using a dissolver or the like.

If the manufactured paint includes secondary particles made by coagulating elements of the pigment particles, the painted surface obtained by applying such paint is not beautiful but rough, therefore aforementioned dispersion step is conducted for dispersing the secondary particle of the pigment particle remained in the paste obtained by the pre-kneading step in single particles.

A sand grind mill is the dispersing device using media to conduct dispersion more effectively in the dispersion step and dispersing the paste obtained by the pre-kneading step continuously.

As shown in FIG. 6, the sand grind mill as a vertical vessel 2 equipped with media, for example, glass beads having a particle diameter of 2 to 3 mm and a shaft 3 rotating in the vessel 2 and stirrer members consisting of circular discs 50 protruding in an outer circumferential direction of the shaft are provided on the shaft 3 at regular intervals.

An introducing port 24 for introducing paste obtained by the pre-kneading step in the vessel is provided at a lower end of the vessel 2 and an discharge port 25 for taking out a dispersed mill base is provided at an upper side of the vessel 2, furthermore, a screen is provided as a separating means 26 for separating media from the mill base taken from the discharge port 25.

In the sand grind mill shown in FIG. 6, an outer circumference of the vessel 2 is surrounded with a jacket 5 at a fixed space and the space of which is arranged as a duct 51, for a flow of cooling media, located between an outer wall surface of the vessel 2 and an inner wall surface of the jacket 5 and the duct in which the cooling media such as cooling water is introduced for heat exchange to cool heat generated by dispersion.

In the sand grind mill above mentioned consistution, when the shaft 3 is rotated in the vessel 2, the media is moved with high speed in the vessel 2 by rotating the stirrer members (discs 50) equipped with the shaft 3 then the paste introduced from the introducing port 24 is dispersed with shearing force of the media.

The mill base obtained by dispersion of the paste as mentioned above is moved upward in the vessel 2 and the media is separated from the mill base through the screen 26 then the mill base is taken from the discharge port 25 and sent to the following steps such as the dissolving step.

There exists a sand grind mill having a horizontal vessel as an improved product of the aforementioned sand grind mill and the sand grind mill having the horizontal vessel is advantageous in cleanness or the like compared to the aforementioned vertical sand grind mill.

Furthermore, FIG. 7 shows an example of the other dispersing apparatus using media. The dispersing device 1 is comprised of pin-shaped stirrer vanes 50′ provided on the lower part of the shaft 3 rotated by a driving source such as a motor, a basket-shaped vessel 2 surrounds the outer circumference of the stirrer vanes 50′, and apertures 7 such as small holes or slits are formed at least on its side wall of the vessel. The dispersing apparatus 1 is submerged in the blend filled in the stirrer vessel 8 and the media are stirred by rotating the stirrer vanes 50′ in the vessel 2 then large particles of solid in the blend are crushed and refined with shearing force generated by the media stirred in the vessel 2, then the refined pigment particles are flowed out through the apertures 7 formed on the side wall or the like of the vessel 2 and flowed into the vessel 2 from the upper side of the vessel 2 through an introducing port 24′ again by being convected in the stirrer vessel 8 then dispersed by being crushed more finely (see, for example, Japanese Laid Open Patent Publications No. 2000-350930).

The dispersing apparatus as above mentioned constitution is a batch-type, therefore can not disperse the introduced paste continuously like the aforementioned sand grind mill, however, the batch-typed dispersing apparatus has good operation efficiency in that the dispersion step and the dissolving step are conducted simultaneously, therefore these dispersing apparatuses are applied selectively according to the use.

In the dispersing apparatus as above mentioned constitution, the blend is passed among the media with shearing force generated by stirring the media in the vessel thereby the blend is dispersed suitably.

However, as explained in the prior art, in the dispersing apparatus of which media are stirred with the stirrer member consisting of the discs provided on the shaft, a plate-shaped discs generates a little resistance by contacting with the media, therefore either a stirring force or a shearing force generated by stirring the media is weak.

Furthermore, the media are stirred relatively easily near the discs, however, the space generally having about 100 mm in width is provided between each of the discs, thereby the media in the space is hard to be stirred with the discs. As a result, the whole volume in the vessel is not used for dispersion effectively and the dispersion is inefficient.

On the otherhand, it is enable to stirr the media in the dispersing apparatus having pins provided on the shaft as stirrer vanes instead of discs mentioned above by repelling the media collided with the rotating pins to the rotational outer circumferential direction.

However, even if the media are repelled by collision with the pins, the moving direction of the media is a fixed circumferential direction, whereby a shearing force is weakend.

Furthermore, a root of the pin (a side of the shaft) is moved more slowly than a point of the pin (a side of the vessel), therefore shearing force generated on the root of the pin is weak.

As a result, the above mentioned dispersing apparatus involves a problem in that the state of the dispersed blends is uneven between the one dispersed by passing near the center of the vessel and the one dispersed by passing near the surface of the wall.

### SUMMARY OF THE INVENTION

The present invention therefore was accomplished in order to eliminate the above-mentioned defects inherent in the prior art and has an object of providing a dispersing apparatus which is capable of stirring the media stored in the vessel uniformly, thereby using the whole volume in the vessel for dispersion and making it possible to disperse efficiently by providing the constitution which can enhance shearing force generated by stirring the media, thereby can be miniaturized compared to a conventional dispersing apparatus and can be dispersed with fixed quality.

In order to accomplish the aforementioned object, a dispersion apparatus 1 of the present invention provides a vessel 2 as a cylindrical container through which a blend is passed, a rotatable shaft 3 inserted in an axial direction of said vessel 2, and stirrer members arranged in said vessel 2 and protruded from a surface of an outer circumference of said shaft 3 in an outer circumferential direction whereby enabling to disperse said blend passed in said vessel 2, characterized in that;

said stirrer members are so constructed as plate-shaped blades 28 having fixed length in an axial direction of said shaft 3, and plate-shaped fins 29 are protruded on an inner wall surface of said vessel 2, and confronting said fins 29 with an outer circumference of a forming position for said stirrer members with a direction toward an inner circumference of said vessel 2, and said plate-shaped fins 29 have a fixed length without contacting with said stirrer members.

In the aforementioned dispersing apparatus 1, a fixed range in an axial direction of said shaft 3 provided in said vessel 2 is arranged a forming area 31 for said blade 28 and a plurality of blades 28 having the same length as said blade forming area 31 is provided at a position on which said shaft 3 is divided in equiangular to a circumferential direction.

Furthermore, said blade forming area 31 may be divided into fixed length equally and partitioned into a plurality of blade forming sections 31a, 31b, 31c, 31d, 31e then a plurality of blades having the same length as said blade forming sections 31a, 31b, 31c, 31d, 31e respectively may be provided at a position partitioning said shaft 3 in equiangular to a circumferential direction.

An inner wall surface of said vessel 2 arranged on an outer circumference of said blade forming area 31 may be arranged a forming area 211 for said fin 29 and a plurality of said fins 29 having the same length as said fin forming area 211 may be provided at a position dividing an inner wall surface of said vessel 2 in equiangular to a circumferential direction.

Furthermore, said fin forming area 211 may be divided into fixed length equally and partitioned into plural fin forming sections 211a, 211b, 211c, 211d, 211e then a plurality of fins having the same length as each said fin forming section may be provided at a position partitioning an inner wall surface of said vessel 2 in equiangular to a circumferential direction.

Length of said blade forming area 31 may be almost the same as a length of a part of which said shaft 3 is inserted in said vessel 2.

Furthermore, it is preferable that a space having Six (6) to Fifteen (15) times wide as a particle diameter of dispersing media stored in said vessel 2 is provided when top positions of protruding direction of said fin 29 and said blade 28 are brought into approximately closely.

Each aforementioned constitution can be applied to a constitution of so-called “sand grind mill”, and in this case said vessel 2 has a sealing construction with an introducing port 24 for a blend near one end of said vessel 2 and an discharge port 25 taking out a dispersed blend near the other end of said vessel 2, and a separating means 26 collecting dispersing media 4 by being passed said blend taken through said discharge port 25 before being passed through said discharge port 25 provided near said discharge port 25 in said vessel 2.

Furthermore, each aforementioned constitution is that an axial direction of said vessel 2 is vertically provided and said vessel 2 formed as a basket-shape having numbers of apertures 7 at least on a lower side wall and the upper and lower openings of said vessel 2 of a cylindrical body 21 are covered with a closure plate 23 and a bottom plate 22 respectively, and said shaft 3 is inserted in said vessel 2 through an insertion hole formed on said closure plate 23, and an introducing port 24′ for said blend is formed by a space between an outer circumference of said shaft 3 and an inner circumference of said hole, and the apparatus of which characterized in that;

said blend is capable to be passed in said vessel 2 by submerging said vessel 2 in a stirrer vessel 8 filled with said blend.

### BRIEF DESCRIPTION OF THE DRAWINGS

The objects and advantages of the invention will become understood from the following detailed description of preferred embodiments thereof in connection with the accompanying drawings in which like numerals designate like elements, and in which;

FIG. 1 is a schematic sectional view of a dispersing apparatus illustrating one embodiment of the present invention;

FIG. 2 is a schematic sectional view illustrating an constitutional example of the blade and fin of the dispersing apparatus;

FIG. 3 is a schematic perspective view illustrating the constitution of the dispersing apparatus providing the rotor;

FIG. 4 is a schematic sectional view illustrating the other constitutional example of the blade and fin of the dispersing apparatus;

FIG. 5 is a schematic sectional view of a dispersing apparatus illustrating the other embodiment of the present invention;

FIG. 6 is a schematic sectional view illustrating a conventional dispersing apparatus; and

FIG. 7 is a schematic sectional view illustrating a conventional dispersing apparatus.

### DETAILED DESCRIPTION OF THE PREFERRED EMBODIMENTS

An embodiment of the invention will now be described with reference to the accompanying drawings.

In the following embodiment, the example of the dispersing apparatus 1 of so-called “vertical-type” using the axial direction of the shaft 3 vertically will be explained and explanation of the constitutional example of so-called “horizontal-type” using the axial direction of the shaft 3 horizontally is omitted, however, the constitution of said dispersing apparatus 1 of the present invention can be applied to the dispersing apparatus of the “horizontal type”.

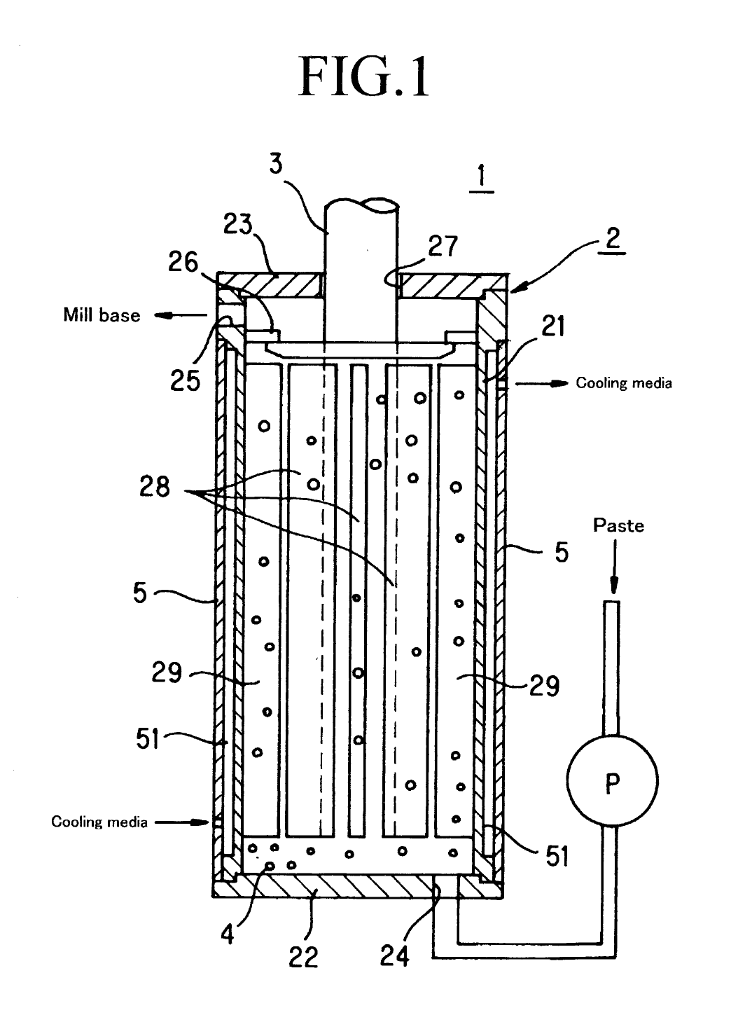

In FIG. 1, a numeral 2 indicates a vessel and it is a cylindrical container formed by arranging an axial direction of a cylindrical body 21, made of a metal plate such as stainless steel, vertically then covering upper and lower openings of the cylindrical body 21 with a bottom plate 22 and a closure plate 23 respectively.

Fixed size of hole is formed at any position of the bottom plate 22 of the vessel 2, for example near a circumference of the bottom plate in the embodiment shown in FIG. 1 and the hole is constituted the introducing port 24 which is capable of introducing the blend as a subject of dispersion, for example a paste obtained by the pre-kneading step in the vessel 2. Furthermore, the introducing port 24 is also capable to be used as an extraction hole for extracting the media 4 stored in the vessel 2.

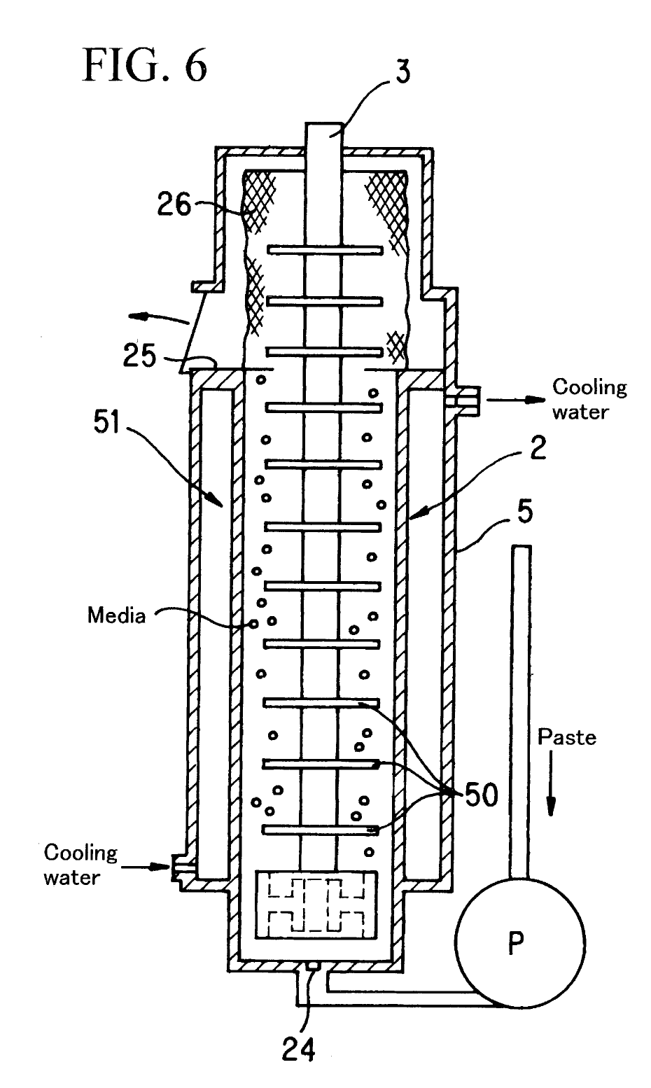

The outer circumference of the vessel 2 is surrounded with the jacket 5 and a space between the outer circumference of vessel 2 and the inner circumference of the jacket 5 is constituted a duct 51 for a cooling media thereby the cooling water and other cooling media can be introduced in the duct 51 for the cooling media as the same same as the one in the sand grind mill shown in FIG. 6 explained as the prior art.

An discharge port 25 is formed on the upper end portion of the vessel 2 covered with the closure plate 23 and the port 25 discharges the mill base obtained by dispersing the introduced paste through the vessel 2 out of the apparatus. In the embodiment shown in FIG. 1, the discharge port 25 is formed on the upper end of the cylindrical portion 21, however, the port 25 may be formed on said closure plate 23.

In the vessel 2, a screen and the other separating means 26 for separating the media mixed in the taken mill base are provided near the discharge port 25 and the media in the mill base are separated or filtered by passing through the separating means 26 thereby the media is prevented from being taken out of the apparatus together with the mill base.

An opening 27 for inserting the shaft 3 so as to rotate freely is formed in the center of the closure plate 23 and the shaft 3 penetrating the opening 27 and rotated with a driving source such as a motor not shown is inserted in the vessel 2 and there is a seal material in a space between the opening 27 and the shaft 3 to seal an inside of the vessel 2 in a liquid tight.

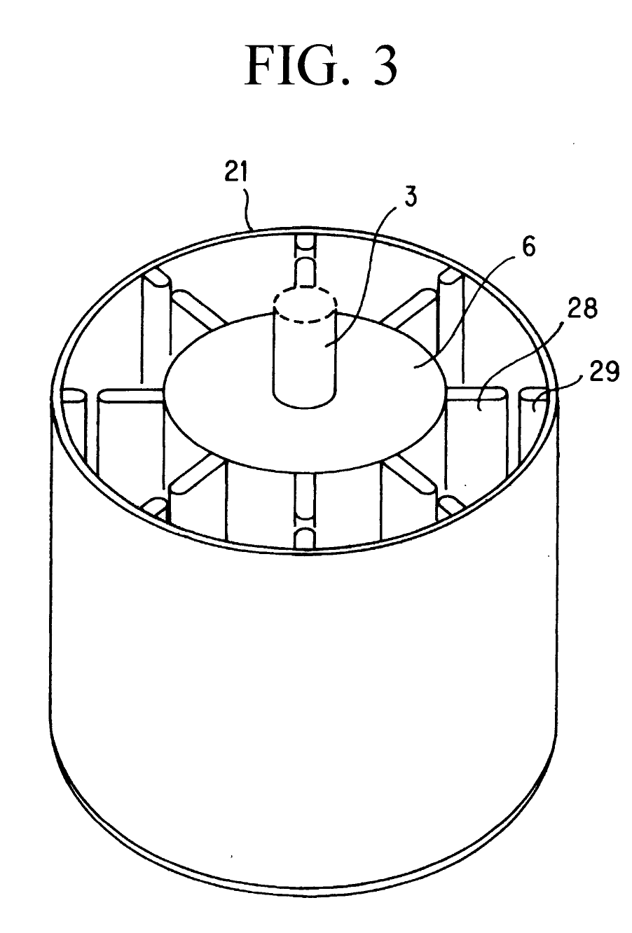

Blades 28 are attached to the shaft 3 inserted in the vessel 2 as stirrer members for stirring the media 4 stored in the vessel 2 by rotating in the vessel 2. In the embodiment shown in FIG. 1, the blades 28 are provided on the outer circumference of the shaft 3 directly, however, the blades 28 may be attached to the shaft 3 through a pillar-shaped rotor 6 attached to the outer circumference of the shaft 3 as shown in FIG. 3.

The blade 28 is formed into fixed length to the axial direction of the shaft 3 for enlarging an area contacted with the media 4 stored in the vessel 2 thereby stirring the media 4 securely and the plurality of blades 28 are provided at the position dividing the outer circumference of the shaft 3 in equiangular.

In the embodiments shown in FIG. 1 to FIG. 3, a blade forming area 31 is composed of almost whole length of a part of which the shaft 3 is inserted in the vessel 2, and the area 31 on which Six (6) pieces of the blades 28 having the same length as the blade forming area 31 are provided at a position dividing the outer circumference of the rotor into six equal parts at an equal angle of 60° of a surface of an outer circumference of the blade forming area 31.

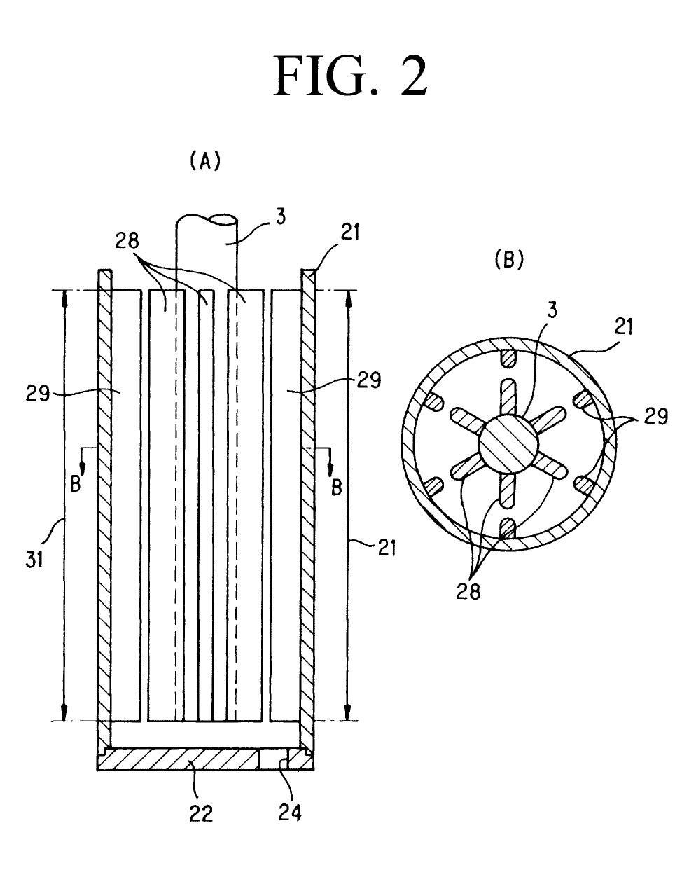

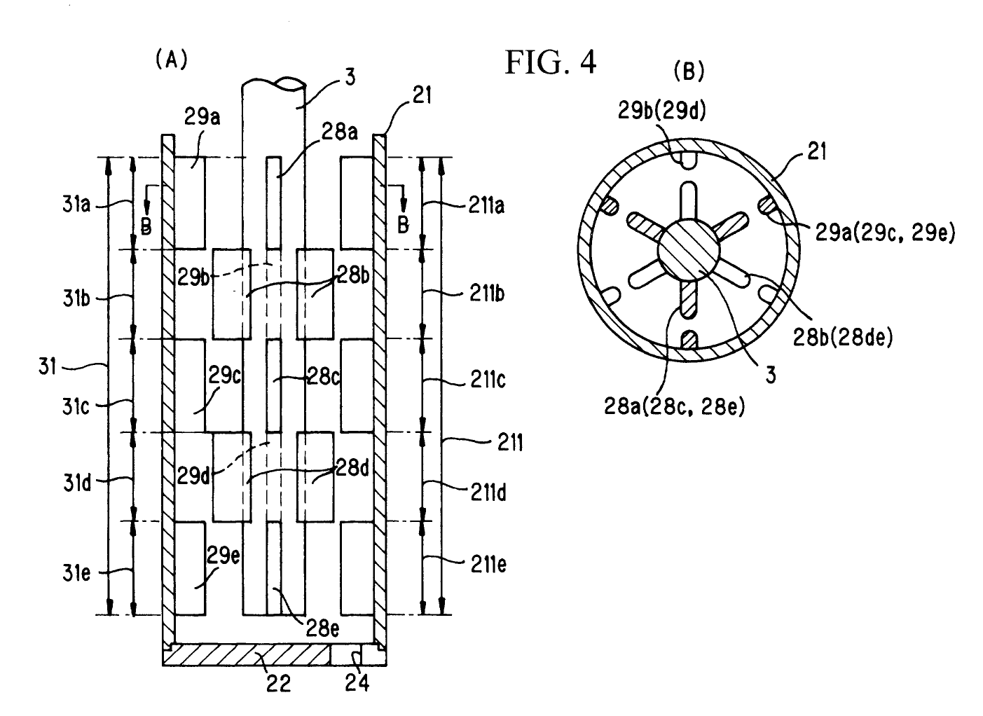

In the embodiments shown in FIG. 1 and FIG. 2(A), the example of which the blade 28 is formed into the same length as the blade forming area 31 for the shaft 3 is explained, however, the blade 28 to be formed is not necessarily has the same length as the blade forming area 31 for the shaft 3, for example, as shown in FIG. 4(A), the blade forming area 31 is divided at equal intervals to the longitudinal direction then forming plural blade forming sections 31a, 31b, 31c, 31d, 31e and blades may be provided on each blade forming sections 31a, 31b, 31c, 31d, 31e.

In the embodiment shown in FIG. 4(A), three pieces of blades are provided on blade forming sections 31a, 31b, 31c, 31d, 31e, respectively at a position of which the outer circumference of the shaft is divided at an equal angle of 120° and a blade forming space between one blade forming section and adjacent other blade forming section is phased in half cycle to the rotational direction of the shaft.

Therefore in the example shown in FIG. 4(A) and FIG. 4(B), the blades 28a, 28c, 28e formed on the blade forming sections 31a, 31c, 31e are arranged at an overlapped position in FIG. 4(B), and the blades 28b, 28d formed on the blade forming sections 31b, 31d are arranged at an overlapped position in FIG. 4(B).

The blades 28 (or 28a to 28e) may be integratedly formed, for example, with the shaft 3 or the rotor 6 attached to the shaft 3, however, it is preferable that the blades 28 (28a to 28e) are constituted by attaching plates formed aside from the shaft 3 or the rotor 6 to the outer peripheries of the shaft 3 or the rotor 6 so as to simply exchange for new one when abrasion or the like is generated by colliding with the media 4 in the dispersion work.

In the present embodiments, the blades 28 (28a to 28e) are constituted by attaching plates made of tungsten carbide used for a cemented carbide tool or the like and relatively hard to generate abrasion to the outer peripheries of the shaft 3 or the rotor 6.

Furthermore, on the inner wall surface of the vessel 2 arranged on the outer circumference of said blade forming area 31, the fins 29 formed into the fixed length to the axial direction of the shaft 3 are protruded to the inner circumferential direction of the vessel 2 without contacting to said blades 28 (28a to 28e), thereby movement of the media which are going to move by being stirred through rotation of the fins 29 is controlled and travelling resistance of the media is enlarged, therefore shearing force generated by stirring the media is increased.

The fins 29 are formed into the fixed length to the axial direction of the shaft 3 and a plurality of the same are formed at the position dividing the surface of the inner circumference of the vessel 2 in equiangular to the circumferential direction for generating appropriate resistance to the media 4 which are going to move to the rotational direction of the shaft 3 with said blade 28 and controlling the movement of the media 4 thereby increasing shearing force generated by stirring with the blade 28.

In the embodiments shown in FIG. 1 to FIG. 3, the inner wall of the vessel 2 arranged on the outer circumference of the blade forming area 31 of the shaft 3 is constituted a fin forming area 211 and six pieces of the fins 29 having the same length as said blades 28 are arranged in the fin forming area so as to divide the inner wall surface of the vessel 2 at an equal angle of 60° to circumferential direction.

Furthermore, the fins divide the fin forming area 211 equally then compose the plural fin forming sections 211a to 211e and three pieces of the fins are provided at the position of which the surface of the inner circumference of the vessel 2 is divided at an equal angle of 120° in each fin forming sections 211a, 211b, 211c, 211d, 211e and a fin forming space between one fin forming section and adjacent other fin forming section is phased in half cycle to the rotational direction of the shaft 3.

Therefore in the examples shown in FIG. 4(A) and FIG. 4(B), the fins 29a, 29c, 29e formed on the fin forming sections 211a, 211c, 211e are arranged at an overlapped position in FIG. 4(B), and the fins 29b, 29d formed on the fin forming sections 211b, 211d are arranged at an overlapped position in the FIG. 4(B).

In FIG. 2(A) and FIG. 2(B), the examples such as the blades 28 having the same length as the blade forming area 31 and the fins 29 having the same length as the fin forming area 211 are combined is shown, furthermore, in FIG. 4(A) and FIG. 4 (B), the example such as the blades 28a to 28e formed by being divided into each blade forming section and the fins 29a to 29e formed by being divided into each fin forming sections 211a to 211e are combined is explained, however, the dispersing apparatus 1 may be constituted by combining the constitutions of the blades 28 formed as the same length as the blade forming area 31 and the fins 29a to 29e formed by being divided into each fin forming sections 211a to 211e, further to the contrary, the dispersing apparatus 1 may be used by combining the blades 28a to 28e formed by being divided into each blade forming sections 31a to 31e and the fin 29 having the same length as the fin forming area 211.

The fins 29 (29a to 29e) may be united with the cylindrical body 21 of the vessel 2, however, it is preferable that the fins are so provided as same as aforementioned blades 28 (28a to 28e) to attach plates made of the material having excellent abrasion resistance, for example, such as a tangsten carbide formed aside from cylindrical body 21 of the vessel 2 to the inner wall surface of the cylindrical body 21 of the vessel 2.

A length for protruding for the blades 28 (28a to 28e) in the outer circumferential direction of the shaft 3 and a lenght for protruding for the fins 29 (29a to 29e) in the center direction of the vessel 2 are decided by relative relation between the both protruding length and the diameter of the media 4 actually used and it is preferable that the protruding length is decided so that space between protruding ends of the blades 28 (28a to 28e) and protruding ends of the fins 29 (29a to 29e) comes to six to fifteen times as wide as the particle diameter of the media 4 in case of which the protruding end of said blades 28 (28a to 28e) and the protruding end of the fin 29 (29a to 29e) are in the most proximal rotational positions.

For example, when ceramic beads, glass beads and steel balls or the like having the diameter of 3 mm are used as media, the protruding length is decided so that the space between the fins 29 (29a to 29e) and the blades 28 (28a to 28e) comes to about 30 mm.

It is not preferable to have been a space between the fins 29 (29a to 29e) and the blades 28 (28a to 28e) being narrower than five (5) times of the diameter of the media 4, because the space between the fins 29 (29a to 29e) and the blades 28 (28a to 28e) is easy to be clogged with or jammed by crosslinked media 4 thereby the blades 28 (28a to 28e), the fins 29 (29a to 29e) and the media 4 are worn down in an early stage respectively.

Furthermore, if the space between the fins 29 (29a to 29e) and the blades 28 (28a to 28e) is over the fifteen times of the diameter of the used media, the media 4 stirred by spinning of the blades 28 (28a to 28e) are passed through the space easily without being received resistance generated by the fins 29 (29a to 29e), therefore the shearing force generated in the portion comes to weak.

Operation efficiency of the dispersing apparatus 1 of the present invention above mentioned constitution is explained that the paste is introduced in the vessel 2 wherein the spherical media 4 consisting of such as the ceramic beads, glass beads, steel balls and the other rigid materials having the diameter of about 2 to 3 mm are thrown and the shaft 3 is rotated through the introducing port 24 formed on the bottom plate of the vessel 2 by a pump P, thereby the paste is passed among the media 4 stored in the vessel 2 then moved to the discharge port 25 provided on the upper side of the vessel 2.

In the above process, althoug the blades 28 attached to the outer circumference of the shaft 3 as a stirrer member of the media 4 are spun in the vessel 2 accompanying with the rotation of the shaft 3, and then the shearing force is generated on the media 4 moved by being stirred with the blades 28, the blades 28 as the stirrer member of the dispersing apparatus 1 of the present invention has the fixed length to the axial direction of the shaft 3 thereby formed widely toward the direction crossing at right angles with the rotational direction of the shaft 3, and therefore, the dispersing apparatus 1 of the present invention has the excellent ability to stir the media 4.

Furthermore, the blades 28 cover the whole area of the blade forming area 31 for example, by making the blades 28 of a plate having the same length as the full length of the blade forming area 31 of the shaft 3 for stirring the media 4 arranged at any position of the outer circumference of the shaft 3 in fixed cycle, thereby the media 4 stirred with the blades 28 (28a to 28e) generate uniform shearing force at any position of the vertical direction in the vessel 2, so the volume in the vessel 2 is to be used for dispersion effectively at any position, and accordingly, the dispersing apparatus 1 of the present invention has the excellent dispersing ability of the paste.

Furthermore, the fins 29 (29a to 29e) protruded from the inner wall of the vessel 2 is operated as an obstacle controlling a movement of the media 4 which are going to move toward the same direction as the rotational direction of the shaft 3 by being moved by collision with the blades 28 (28a to 28e), thereby generating extremely high shearing force by the collision and abrasion between the media 4 which is controlled their movement by the fins 29 (29a to 29e) and the media 4 moved to the rotational direction of the shaft 3 with the blades 28 (28a to 28e).

Accordingly, the paste passing through gaps between the media 4 generating such high shearing force is dispersed appropriately, therefore dispersing performance shown by the dispersing apparatus 1 of the present invention is extremely high.

As mentioned above, in the dispersing apparatus 1 of the present invention, uniform shearing force can be generated at any position in the vessel 2 due to the shape and a constitution of the blades 28 (28a to 28e), thereby the paste passing in the vessel 2 is dispersed uniformly even when the paste is passed through any position, furthermore, the extremely high shearing force is generated by the combination of the fins 29 (29a to 29e) and the blades 28 (28a to 28e), therefore the dispersing performance is relatively extremely high.

As a result, it is possible to miniaturize the dispersing apparatus 1 of the present invention by lowering the height of the vessel 2 compared with the conventional dispersing apparatus to obtain the same dispersion effect thereby.

The blend changed into the mill base by dispersing the paste with shearing force among the media 4 as mentioned above is separated from the media 4 contained in the mill base by passing through the separating means 26 and the mill base separated from the media 4 is taken out of the apparatus through the discharge port 25.

Furthermore, the separated media 4 are worked as dispersing media again by being remained in the vessel 2.

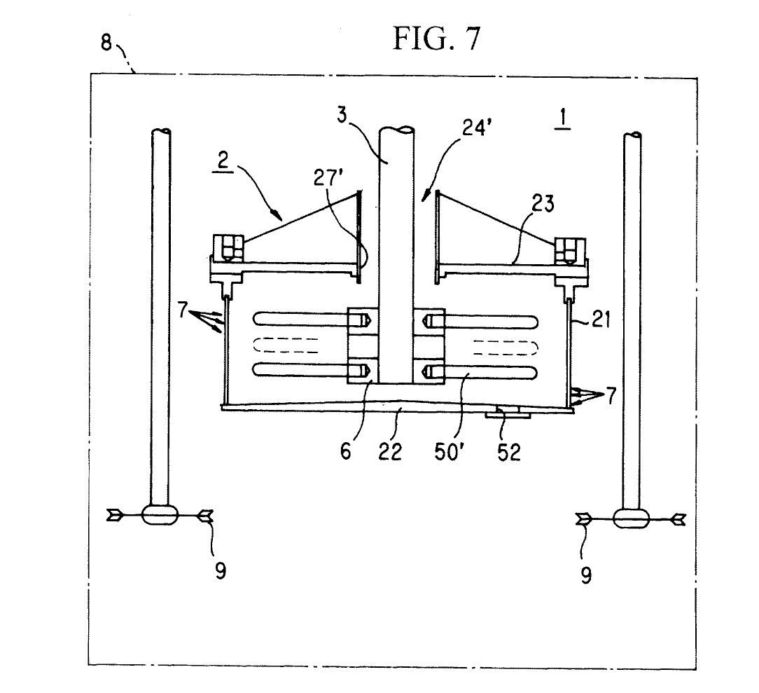

In the embodiments shown in FIG. 1 to FIG. 4, although an explanation was mde for an example applied to so-called “sand grind mill” dispersing the blend (paste) as a subject of dispersion with introducing the same in the vessel 2 continuouosly as mentioned above, the constitution of the present invention is not only applicable to such a continuously-type dispersing apparatus but also applicable to the basket-type dispersing apparatus explained with reference to the FIG. 7 in the prior art.

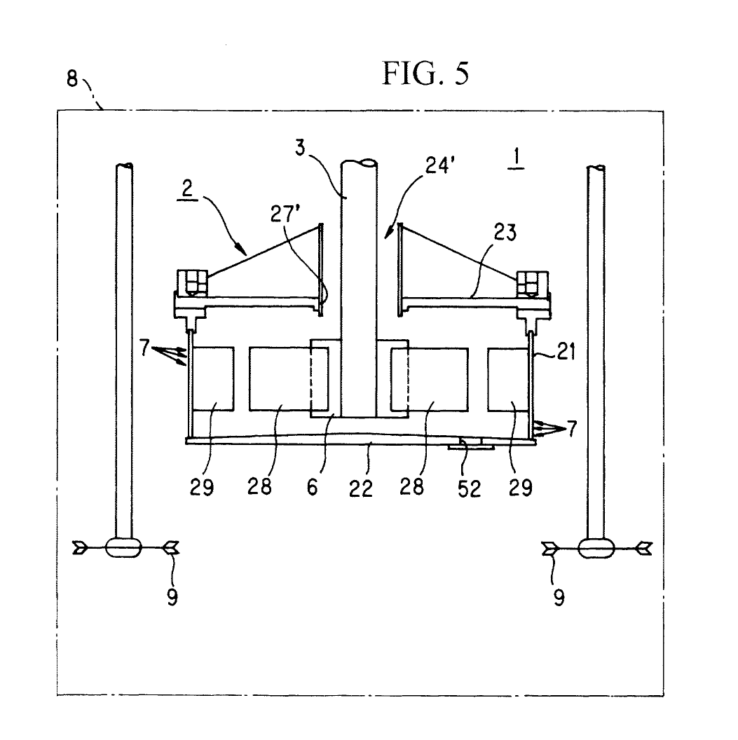

The basic constitution of the dispersing apparatus 1 shown in FIG. 5 is the same as that of the dispersing apparatus explained with reference to FIG. 7 in the prior art, however, in the conventional dispersing apparatus, the media 4 are stirred with pins 50′ provided on the shaft 3, on the other hand, in the dispersing apparatus 1 shown in FIG. 6, the example of which the blades 28 which are the same as the blade explained in the embodiments shown in FIG. 1 to FIG. 4 are provided and fins are attached to the inner wall of the basket-shaped vessel 2 is explained.

In the dispersing apparatus 1, numbers of apertures 7 consisting of such as piercings and slits penetrating between surfaces of inner and outer walls of the vessel 2 are formed and an opening 27′ in which the shaft 3 is inserted is formed on the closure plate 23 covering the upper side of the vessel 2 then the introducing port 24′ introducing the blend mentioned later from the space formed between the inner circumference of the opening 27′ and the outer circumference of the shaft 3 to the inside of the vessel 2 is formed.

A hole 52 formed on the bottom plate 22 of the vessel 2 is not used for introducing fluid as a subject of dispersion in the vessel 2 as the introducing port in the dispersing apparatus shown in aforementioned FIG. 1 to FIG. 4 but used for extracting the media 4 stored in the vessel 2 in the case of washing or the like.

In the dispersing apparatus constituted as mentioned above, as shown in FIG. 5, the media 4 are stored in the vessel 2 then the vessel 2 is submerged in the stirrer vessel 8 filled with the blend as a subject of dispersion and the blades 28 are rotated by the rotation of the shaft 3 in the vessel 2 then granules of pigment particles or the like collected with shearing stress among the media 4 moved by the rotation of the blades 28 are dispersed and the blend dispersed as mentioned above is flown from the apertures 7 such as small holes or slits formed on the side wall of the vessel 2 and the blend flown to a lower side of the vessel 2 is convected to the upper side of the vessel 2 by the rotation of a vane for flowing fluid 9 provided on the lower side of the vessel 2 then introduced in the vessel 2 through the introducing port 24′ formed between the closure plate 23 and the shaft 3 again, thereby the dispersion is repeated and the blend is dispersed.

In the dispersing apparatus 1, the media 4 stored in the vessel 2 can be stirred uniformly and uniform shearing force can be generated at any position in the vessel 2 by providing the blades 28 (28a to 28e) and the fins 29 (29a to 29e) having the same constitution with the aforementioned embodiments shown in FIG. 1 to FIG. 4, furthermore, dispersing performance of the blend is improved by generating extremely high shearing force through the collision between the media 4 which are going to move to the rotational direction of the shaft 3 with the blades 28 (28a to 28e) and the media 4 which are controlled their movement with the fins 29 (29a to 29e) as a resistance to the movement of the media 4 in the rotational direction.

A dispersing apparatus which is capable of stirring the media stored in the vessel uniformly, therefore also capable of using the whole volume in the vessel for dispersion effectively owing to the aforementioned constitution of the present invention, and making it possible to be miniaturized compared to a conventional dispersing apparatus due to its high dispersion efficiency and capable of conducting dispersion with regular quality by providing the constitution which can enhance shearing force generated by stirring the media can be provided.

Thus the broadest claims that follow are not directed to a machine that is configure in a specific way. Instead, said broadest claims are intended to protect the heart or essence of this breakthrough invention. This invention is clearly new and useful. Moreover, it was not obvious to those of ordinary skill in the art at the time it was made, in view of the prior art when considered as a whole.

Moreover, in view of the revolutionary nature of this invention, it is clearly a pioneering invention. As such, the claims that follow are entitled to very broad interpretation so as to protect the heart of this invention, as a matter of law.

It will thus be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described;

What is claimed is:

1. In a dispersing apparatus wherein a vessel as a cylindrical container through which a blend is passed, a rotatable shaft inserted in an axial direction of said vessel and stirrer members arranged in said vessel and protruded from a surface of an outer circumference of said shaft in an outer circumferential direction whereby enabling to disperse said blend passed in said vessel,
characterized in that;
said stirrer members are so constructed as plate-shaped blades having fixed length in an axial direction of said shaft, and
plate-shaped fins are protruded on an inner wall surface of said vessel, and
confronting said fins with an outer circumference of a forming position for said stirrer members with a direction toward an inner circumference of said vessel, and
said plate-shaped fins have a fixed length without contacting with said stirrer members.

2. A dispersing apparatus according to claim 1, wherein a fixed range in an axial direction of said shaft provided in said vessel is arranged a forming area for said blade and a plurality of blades having the same length as said blade forming area is provided at a position on which said shaft is divided in equiangular to a circumferential direction.

3. A dispersing apparatus according to claim 1, wherein a fixed range in an axial direction of said shaft provided in said vessel is arranged a forming area for said blade and said blade forming area is divided into fixed length equally and partitioned into a plurality of blade forming sections then a plurality of blades having the same length as said blade forming sections respectively are provided at a position partitioning said shaft in equiangular to a circumferential direction.

4. A dispersing apparatus according to any one of claims 1 to 3, wherein an inner wall surface of said vessel arranged on an outer circumference of said blade forming area is arranged a forming area for said fin and a plurality of said fins having the same length as said fin forming area are provided at a position dividing an inner wall surface of said vessel in equiangular to a circumferential direction.

5. A dispersing apparatus according to any one of claims 1 to 3, wherein an inner wall surface of said vessel arranged on an outer circumference of said blade forming area is arranged a forming area for said fin and said fin forming area is divided into fixed length equally and partitioned into plural fin forming sections then a plurality of fins having the same length as each said fin forming section are provided at a position partitioning an inner wall surface of said vessel in equiangular to a circumferential direction.

6. A dispersing apparatus according to any one of claims 2 to 5, wherein length of said blade forming area is almost the same as a length of a part of which said shaft is inserted in said vessel.

7. A dispersing apparatus according to any one of claims 1 to 6, wherein a space having six (6) to fifteen (15) times wide as a particle diameter of dispersing media stored in said vessel is provided when top positions of protruding direction of said fin and said blade are brought into approximately closely.

8. A dispersing apparatus according to any one of claims 1 to 7, wherein said vessel has a sealing construction with an introducing port for a blend near one end of said vessel and an discharge port discharging a dispersed blend near the other end of said vessel, and a separating means collecting dispersing media by being passed said blend taken through said discharge port before being passed through said discharge port provided near said discharge port in said vessel.

9. A dispersing apparatus according to any one of claims 1 to 7, wherein an axial direction of said vessel is vertically provided and said vessel formed as a basket-shape having numbers of apertures at least on a lower side wall and the upper and lower openings of said vessel of a cylindrical body are covered with a closure plate and a bottom plate respectively, and a shaft is inserted in said vessel through an insertion hole formed on said closure plate, and an introducing port for said blend is formed by a space between an outer circumference of said shaft and an inner circumference of said hole, and the apparatus of which characterized in that;
said blend is capable to be passed in said vessel by submerging said vessel in a stirrer vessel filled with said blend.

10. A dispersing apparatus according to any one of claim 1, wherein an inner wall surface of said vessel arranged on an outer circumference of said blade forming area is arranged a forming area for said fin and a plurality of said fins having the same length as said fin forming area are provided at a position dividing an inner wall surface of said vessel in equiangular to a circumferential direction.

11. A dispersing apparatus according to any one of claim 1, wherein an inner wall surface of said vessel arranged on an outer circumference of said blade forming area is arranged a forming area for said fin and said fin forming area is divided into fixed length equally and partitioned into plural fin forming sections then a plurality of fins having the same length as each said fin forming section are provided at a position partitioning an inner wall surface of said vessel in equiangular to a circumferential direction.

12. A dispersing apparatus according to any one of claim 3, wherein length of said blade forming area is almost the same as a length of a part of which said shaft is inserted in said vessel.

13. A dispersing apparatus according to any one of claim 4, wherein a space having 6 (six) to 15 (fifteen) times wide as a particle diameter of dispersing media stored in said vessel is provided when top positions of protruding direction of said fin and said blade are brought into approximately closely.

14. A dispersing apparatus according to any one of claim 1, wherein said vessel has a sealing construction with an introducing port for a blend near one end of said vessel and an discharge port discharging a dispersed blend near the other end of said vessel, and a separating means collecting dispersing media by being passed said blend taken through said discharge port before being passed through said discharge port provided near said discharge port in said vessel.

15. A dispersing apparatus according to any one of claim 1, wherein an axial direction of said vessel is vertically provided and said vessel formed as a basket-shape having numbers of apertures at least on a lower side wall and the upper and lower openings of said vessel of a cylindrical body are covered with a closure plate and a bottom plate respectively, and a shaft is inserted in said vessel through an insertion hole formed on said closure plate, and an introducing port for said blend is formed by a space between an outer circumference of said shaft and an inner circumference of said hole, and the apparatus of which characterized in that;
said blend is capable to be passed in said vessel by submerging said vessel in a stirrer vessel filled with said blend.
